(19) United States
(12) Patent Application Publication
(10) Pub. No.: US 2026/0131233 A1
(43) Pub. Date: May 14, 2026

(54) MOTION MIMICKING GAMEPLAY

(71) Applicant: Sony Interactive Entertainment Inc., Tokyo (JP)

(72) Inventors: Zade Lobo, San Mateo, CA (US); Ayush Raina, San Mateo, CA (US); Hubert Lu, San Mateo, CA (US); Kusha Sridhar, San Mateo, CA (US)

(21) Appl. No.: 18/944,383

(22) Filed: Nov. 12, 2024

(51) Int. Cl. A63F 13/213

(52) U.S. Cl. CPC A63F 13/213

(57) ABSTRACT

Techniques are provided to detect the motion of a player of a computer game and both convert images of the motion to text to allow another player to attempt to mimic it, with a multimodal model judging how well the second player mimics the first, and to map the player motion onto a player character (PC) in the game.

### FIELD

The present application relates generally to player motion mimicking computer game play.

### BACKGROUND

Computer games typically are controlled by players manipulating game controllers to control player characters (PC) in the game.

### SUMMARY

As understood herein, the connection or affinity between a player and a computer game and specifically a PC can be enhanced.

Accordingly, an apparatus includes at least one processor system configured to receive images of a player of a computer game making motions, and convert the images to text description of the motions. The processor system also is configured to send the text description to a device of a companion and image the companion attempt to mimic the motion described by the text description. The processor system is configured to output an indication of success of the companion mimicking the motion.

In some embodiments the processor system can be configured to determine success of the companion mimicking the motion at least in part using cosine similarity.

In some examples, the processor system can be further configured to map the motions of the player to at least one player character (PC) of a computer game controlled by the player. This may be done using keyframes from the images. The processor system can be configured to map the motions of the player to the PC responsive to a determination that game context is appropriate for mapping. In contrast, the processor system can be configured to not map the motions of the player to the PC responsive to a determination that game context is inappropriate for mapping.

In another aspect, an apparatus includes at least one processor system configured to receive images of a player of a computer game making motions, and map the motions of the player to at least one player character (PC) of a computer game controlled by the player.

In another aspect, a method includes receiving images of a player of a computer game making motions, and executing at least one of “A”, “B”. “A” includes mapping the motions of the player to at least one player character (PC) of a computer game controlled by the player. On the other hand, “B” includes converting the images to text description of the motions, sending the text description to a device of a companion, imaging the companion attempt to mimic the motion described by the text description, and outputting an indication of success of the companion mimicking the motion.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example specific system;

FIG. 3 is a block diagram of present techniques;

FIG. 4 illustrates example overall logic in example flow chart format;

FIG. 5 illustrates example logic in example flow chart format for training a model to generate text from player motion signals;

FIGS. 6 and 7 illustrate respective screenshots of user interfaces (UI) related to FIG. 4;

FIG. 8 illustrates example logic in example flow chart format for mapping player movements onto a player character (PC) in a computer game;

FIG. 9 illustrates a UI consistent with FIG. 8; and

FIG. 10 illustrates example logic in example flow chart format for training a model to determine whether game context is appropriate for mapping player motion onto a PC.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

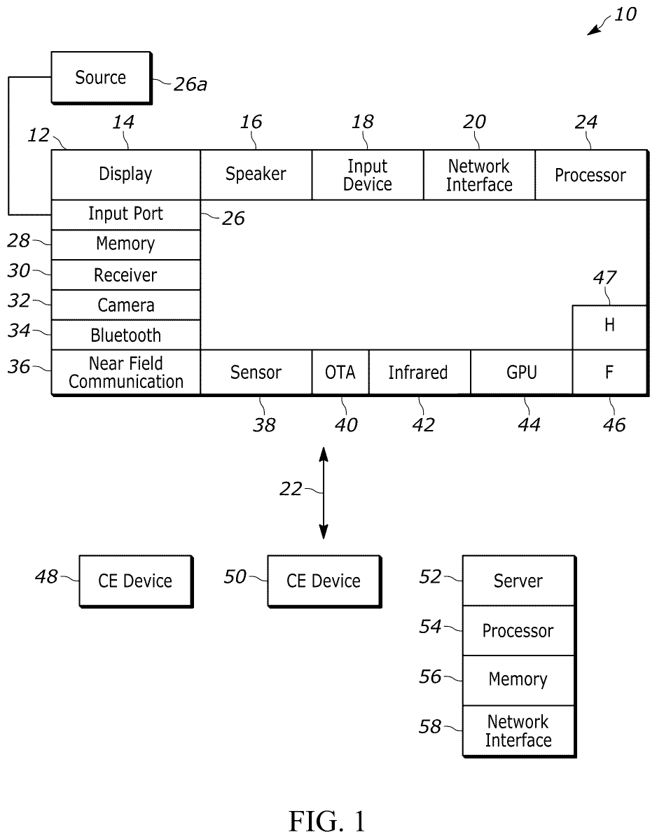

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative models such as large language models (LLM) such as generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

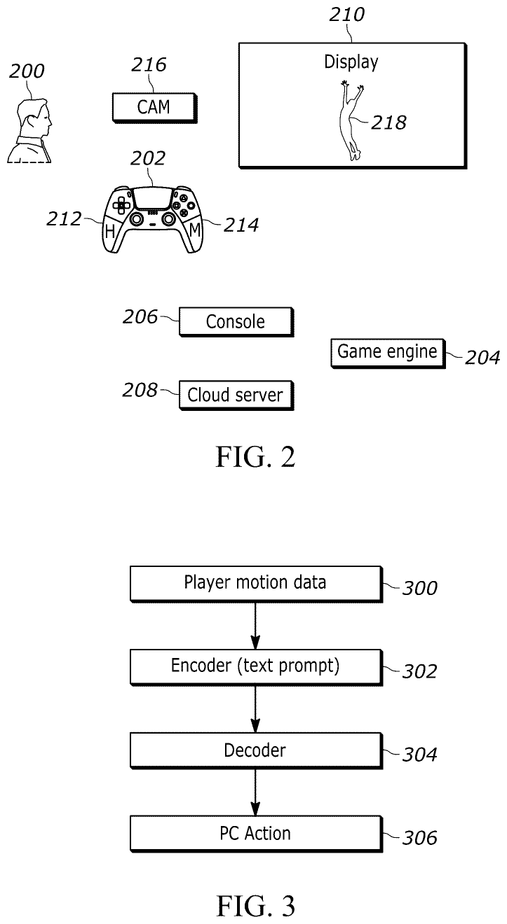

Refer now to FIG. 2. A player 200 can manipulate a computer game controller 202 to control a computer game from a game engine 204 hosted by a computer game console 206 and/or cloud server 208 and presented on a display 210. In the example shown, the controller 202 may include one or more haptic generators 212 and one or more motion sensors 214 such as inertial measurement units (IMU), gyroscopes, magnetometers, and the like. A camera 216 which may be part of the controller 202 or display 210 or console 206 can image the player 200 to detect player motion by means of machine vision implemented on the player images.

The system shown in FIG. 2 and represented further in FIG. 3 can be used to automatically generate motions of a player character (PC) 218 in a computer game as well as additional purposes using artificial intelligence (AI) based on player motion 300. The player motion 300 may be derived from signals from the motion sensor 214 on the controller 202, machine vision implemented on images from the camera 216, and other sources of player motion signals.

An encoder 302 generates text prompts that are sent to a decoder 304, which may be implemented by a machine learning (ML) model trained to generate commands for specific PC motions from text prompts. The output of the decoder 304 is sent to the game engine 204 to map player motion onto the PC 218.

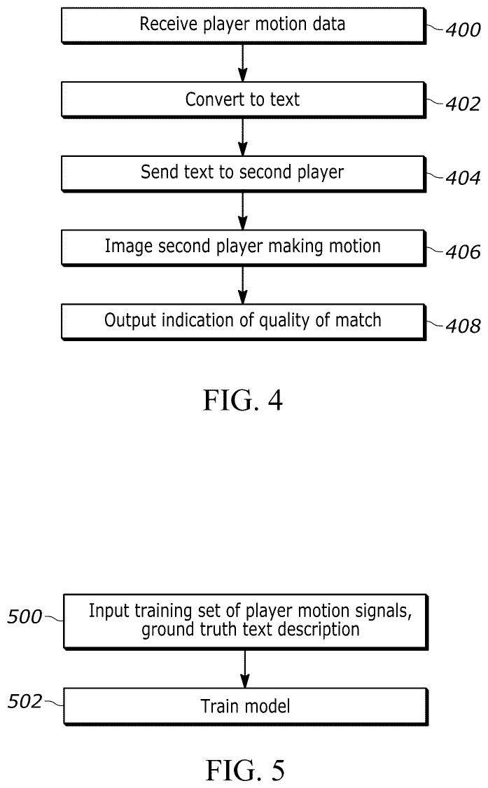

FIG. 4 illustrates overall logic for a first application of present principles. Commencing at state 400, player motion data is received from e.g., the camera 216. The motion data is converted to a text description of the motion at state 402.

Moving to state 404, the text from state 402 is sent via wired or wireless communications paths to a second player such as via a game console or cloud server for presentation of the text on a display associated with the second player. The second player attempts to mimic the motion and is imaged while doing so at state 406. An indication is output at state 408 as to how well the second player mimicked the first player's motion represented in the text prompt from state 402. The indication at state 408 may be generated based on a cosine similarity comparison between the text and the image of the second player making the motion using vectors in encoding space.

To tarin a ML model to generate text at state 402 and judge cosine similarity at state 408, it may be trained according to FIG. 5. Commencing at state 500 in FIG. 5, a training set of data is input to a ML model to train the model at state 502 to generate text from player motion signals. The input training can include sample player motion data with ground truth text descriptions of the motion signals.

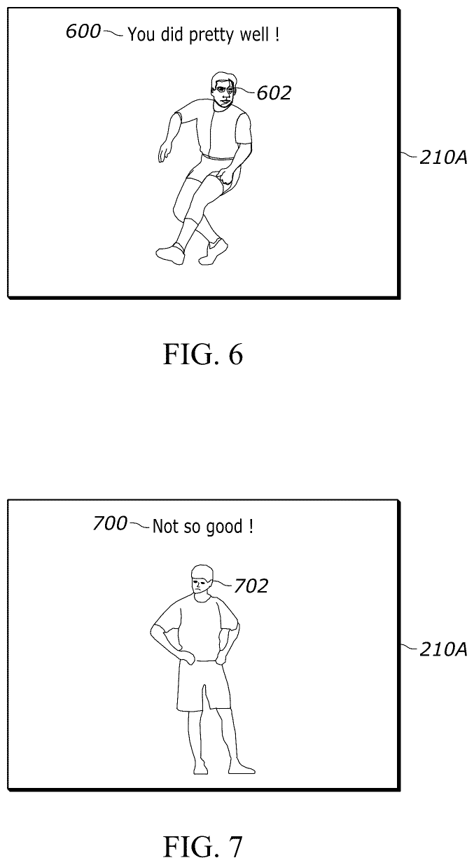

FIG. 6 illustrates a first output of the model in which the display 210A of the second player presents an encouraging prompt 600 that the player did well in complying with the text description of motion the player attempted to make. An image 602 of the player may be presented doing the motion. In contrast, FIG. 7 illustrates a second output of the model in which the display 210A of the second player presents a discouraging prompt 700 that the player did not do well in complying with the text description of motion the player attempted to make. An image 702 of a sad face may be presented. The display 210A may be a Tv display or tablet display or cell phone display.

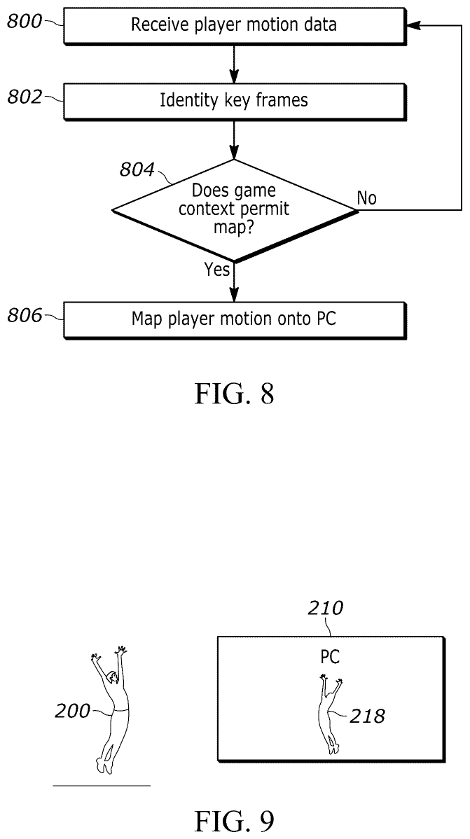

FIG. 8 illustrates additional logic. Note that the logic of FIG. 8 may be enabled by the player by, for example, pressing a predetermined button on the controller 202 shown in FIG. 2 to indicate that the player wishes to have his motion mapped to his PC 218.

Player motion data is received at state 800 consistent with disclosure above, typically in the form of a video of the player jumping, waving his hands, etc. Moving to state 802, if desired keyframes are identified in the video using, e.g., machine vision. For example, frames in which arm and hand is waving or legs moving may be defined to be keyframes.

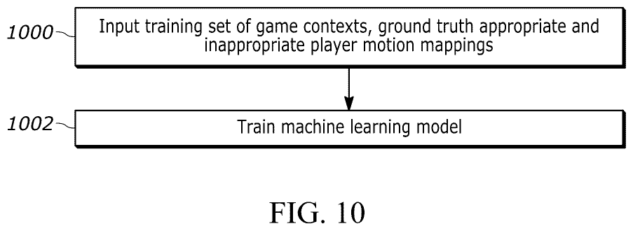

If desired, the logic may move to state 804 to determine whether the current game state is appropriate for mapping player motion onto the PC 218 shown in FIG. 2. For example, if the PC is sleeping and the player jumps, making the PC jump when asleep is not appropriate. On the other hand, if a rock is falling in the game and the PC is standing still, mapping a jump by the player onto the PC to avoid the rock is appropriate. The determination of appropriateness may be made by a ML model trained as set forth below according to FIG. 10.

If the game state permits, the logic moves to state 806 to map the player motion onto the PC. An example is illustrated in FIG. 9, in which a player 200 leaps with arms outstretched and in response the PC 218 leaps with arms outstretched.

FIG. 10 illustrates that a training set of data can be input to a ML model at state 1000 to train the model at state 1002 to learn whether a particular player movement is appropriate for a given game context. The training set can include sample game contexts paired with ground truth samples of motions that are inappropriate for the context and appropriate for the context.

While the particular embodiments are herein shown and described in detail, it is to be understood that the subject matter which is encompassed by the present invention is limited only by the claims.

What is claimed is:

1. An apparatus comprising:
at least one processor system configured to:
receive images of a player of a computer game making motions;
convert the images to text description of the motions;
send the text description to a device of a companion;
image the companion attempt to mimic the motion described by the text description; and
output an indication of success of the companion mimicking the motion.

2. The apparatus of claim 1, wherein the processor system is configured to determine success of the companion mimicking the motion at least in part using cosine similarity.

3. The apparatus of claim 1, wherein the processor system is configured to map the motions of the player to at least one player character (PC) of a computer game controlled by the player.

4. The apparatus of claim 1, wherein the processor system is configured to map the motions of the player to the PC at least in part using keyframes from the images.

5. The apparatus of claim 1, wherein the processor system is configured to map the motions of the player to the PC responsive to a determination that game context is appropriate for mapping.

6. The apparatus of claim 1, wherein the processor system is configured to not map the motions of the player to the PC responsive to a determination that game context is inappropriate for mapping.

7. An apparatus comprising:
at least one processor system configured to:
receive images of a player of a computer game making motions; and
map the motions of the player to at least one player character (PC) of a computer game controlled by the player.

8. The apparatus of claim 7, wherein the processor system is configured to map the motions of the player to the PC at least in part using keyframes from the images.

9. The apparatus of claim 7, wherein the processor system is configured to map the motions of the player to the PC responsive to a determination that game context is appropriate for mapping.

10. The apparatus of claim 7, wherein the processor system is configured to not map the motions of the player to the PC responsive to a determination that game context is inappropriate for mapping.

11. The apparatus of claim 7, wherein the processor system is configured to:
convert the images to text description of the motions;
send the text description to a device of a companion;
image the companion attempt to mimic the motion described by the text description; and
output an indication of success of the companion mimicking the motion.

12. The apparatus of claim 11, wherein the processor system is configured to determine success of the companion mimicking the motion at least in part using cosine similarity.

13. A method comprising:
receiving images of a player of a computer game making motions; and
executing at least one of “A”, “B”, wherein “A” comprises mapping the motions of the player to at least one player character (PC) of a computer game controlled by the player; and
“B” comprises converting the images to text description of the motions, sending the text description to a device of a companion, imaging the companion attempt to mimic the motion described by the text description, and outputting an indication of success of the companion mimicking the motion.

14. The method of claim 13, comprising executing “A”.

15. The method of claim 14. comprising mapping the motions of the player to the PC at least in part using keyframes from the images.

16. The method of claim 14. comprising mapping the motions of the player to the PC responsive to a determination that game context is appropriate for mapping.

17. The method of claim 14. comprising not mapping the motions of the player to the PC responsive to a determination that game context is inappropriate for mapping.

18. The method of claim 13, comprising executing “B”.

19. The method of claim 18, comprising determining success of the companion mimicking the motion at least in part using cosine similarity.

20. The method of claim 13, comprising executing both “A” and “B”.
